(19) United States
(12) Patent Application Publication
(10) Pub. No.: US 2014/0122151 A1
(43) Pub. Date: May 1, 2014

(54) DISPLAYING TEMPORAL AND LOCATION INFORMATION

(71) Applicant: Cameron Edwards, New York, NY (US)

(72) Inventor: Cameron Edwards, New York, NY (US)

(21) Appl. No.: 14/067,565

(22) Filed: Oct. 30, 2013

Related U.S. Application Data
(60) Provisional application No. 61/720,013, filed on Oct. 30, 2012.

(51) Int. Cl. G06Q 10/10

(52) U.S. Cl. CPC G06Q 10/1093
USPC 705/7.18

(57) ABSTRACT

For displaying temporal information, a client receives the display start time and a display end time. The client further receives a display location. The client displays on a map each event of a plurality of events with an event location within an area of the map and an event time interval matching the display start time and the display end time.

### CROSS-REFERENCE TO RELATED APPLICATIONS

This application claims priority to U.S. Provisional Patent Application No. 61/720,013 entitled “DISPLAYING TEMPORAL AND LOCATION INFORMATION” and filed on Oct. 30, 2012 for Cameron Edwards, which is incorporated herein by reference.

### FIELD

The subject matter disclosed herein relates to displaying information and more particularly relates to displaying temporal and location information.

### BACKGROUND

### Description of the Related Art

Information about events typically includes both temporal and location information.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a client/server system;

FIG. 2 is a schematic block diagram illustrating one embodiment of a computer;

FIG. 3 is a schematic block diagram illustrating one embodiment of an event database;

FIG. 4 is a schematic block diagram illustrating one embodiment of an event entry;

FIG. 5 is a schematic diagram illustrating one embodiment of matching times;

FIG. 6 is a schematic flow chart diagram illustrating one embodiment of a method for displaying temporal information;

FIG. 7 is a screenshot illustrating one embodiment of a map; and

FIG. 8 is a screenshot illustrating one alternate embodiment of a map.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The description of elements in each figure may refer to elements of proceeding figures. Like numbers refer to like elements in all figures, including alternate embodiments of like elements.

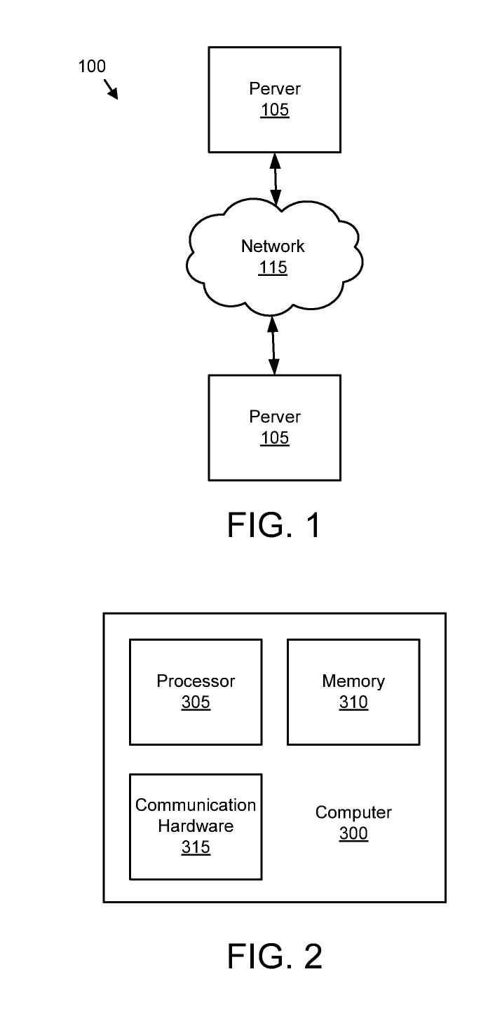

FIG. 1 is a schematic block diagram illustrating one embodiment of a client/server system 100. The system 100 includes a server 105, a network 110, and a client 115. The network 110 may be the Internet. Alternatively, the network 110 may be a mobile telephone network, a wide-area network, a local area network, or the like. The client 115 may be a computer workstation, a portable computer, a tablet computer, a mobile telephone, a personal digital assistant, or the like. The client 115 may access the server 105 using a browser, and application, or combinations thereof.

The client 115 may access event information from the server 105 through the network 110 as will be described hereafter. In the past, accessing event information typically involved identifying type of activity, a date, or a range of dates. The events meeting these selection criteria are then displayed as a list. However, such a display made it difficult to find an event with both an appropriate location and an appropriate time. The embodiments described herein event information for a temporal range on a map to simplify the display and identification of appropriate event.

FIG. 2 is a schematic block diagram illustrating one embodiment of a computer 300. The computer 300 may be the server 105. Alternatively, the computer 300 may be the client 115. The computer 300 includes a processor 305, a memory 310, and communication hardware 315. The memory 310 may be a computer readable storage medium such as a semiconductor storage device, a hard disk drive, a holographic storage device, a micromechanical storage device, or the like. The memory 310 may store computer readable program code. The processor 305 may execute the computer readable program code. The communication hardware 315 may communicate with other devices.

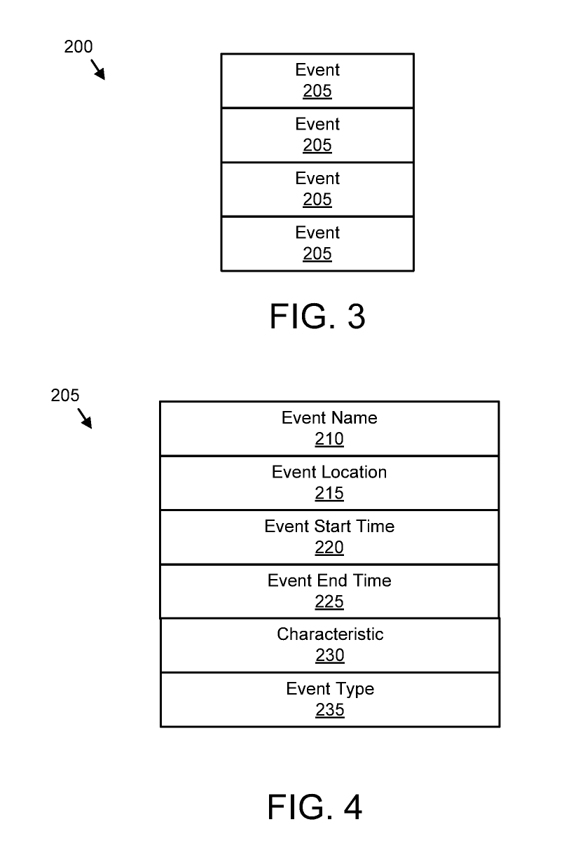

FIG. 3 is a schematic block diagram illustrating one embodiment of an event database 200. The database 200 includes a plurality of event entries 205. Each event entry 205 describes an event.

In one embodiment, the database 200 is stored on the server 105 and/or a storage system in communication with the server. In an alternate embodiment, the database 200 or a portion of the database 200 is copied to the client 115.

FIG. 4 is a schematic block diagram illustrating one embodiment of the event entry 205. In the depicted embodiment, the event entry 205 includes an event name 210, an event location 215, an event start time 220, an event end time 225, a characteristic 230, and an event type 235. One of skill in the art will recognize that the embodiments may be practiced with event entries 205 that include additional information.

The event name 210 may uniquely identify the event. For example, the event name 210 may be “Beethoven Festival.” The event location 215 may be the venue for the event, a starting location for the event, a participant location for the event, an ending location for the event, a spectator location for the event, an area of the event, or combinations thereof. The event location 215 may be defined with a single spatial location such as global positioning system coordinates, an address, a plurality of spatial locations defining boundaries of the event, or combinations thereof.

The event start time 220 may indicate when the event begins. The event end time 225 may indicate when the event ends. The characteristic 230 may include an event genre, keywords describing the event, a participant age range, a content rating, ad event description, or combinations thereof. The event type 235 may be one of a performance, an exhibition, and a sporting event. In one embodiment, the event type 235 is limited to specified types.

In one embodiment, the event database 200 is searchable by the event name 210, the event location 215, the event start time 220, the event end time 225, the characteristic 230, and the event type 235. The client 115 may employ a display start time, a display end time, and a display location to discover and display events from the event database 200. In addition, the client 115 may employ the characteristic 230 to discover display events.

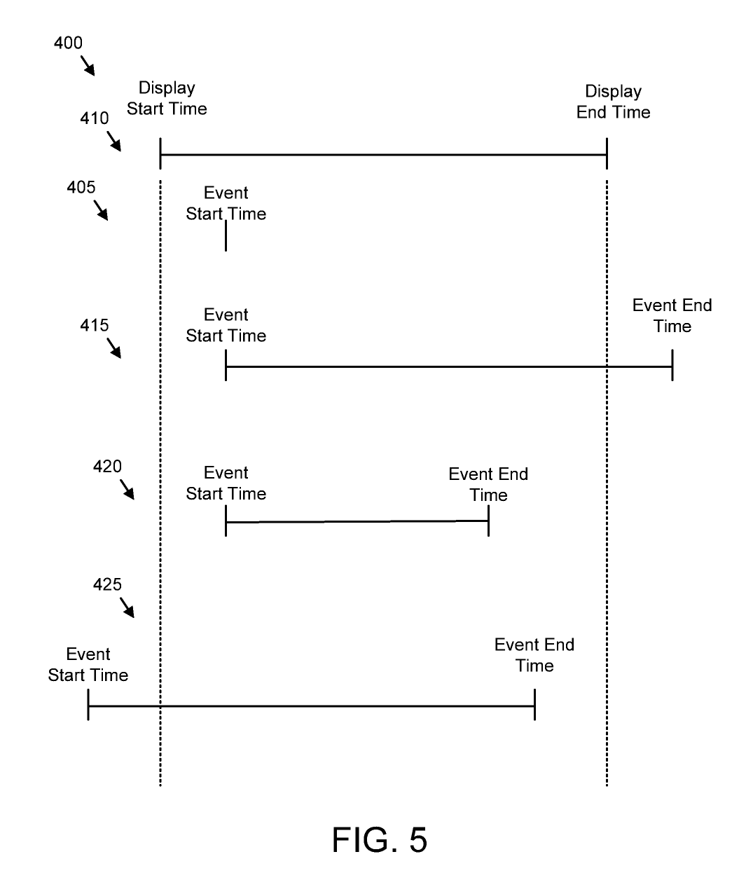

FIG. 5 is a schematic diagram illustrating one embodiment of matching times 400. The matching times 400 display embodiments whereby a display start time and a display end time match an event time interval. A display interval 410 with the display start time and a display end time is shown as a line interval.

An event time interval 405 comprising an event start time is also shown. In one embodiment, the event time interval 405 matches the display start time and the display end time if an event start time of the event time interval 405 is subsequent to the display start time and prior to the display end time.

Another event time interval 415 is shown with an event start time subsequent to the display start time and prior to the display end time. In addition, an event end time of the event time interval 415 is subsequent to the display end time. In one embodiment, the event time interval 415 matches the display start time and the display end time as the event time interval 415 overlaps the display interval 410.

Still another event time interval 420 is shown. The event time interval 420 may match the display start time and the display end time of the display interval 410 as the event time interval 420 is within the display interval 410 between the display start time the display end time as shown.

Another event time interval 425 is shown with the event start time prior to the display start time and an event end time subsequent to the display start time and prior to the display end time. The event time interval 425 may match the display start time and the display end time of the display interval 410.

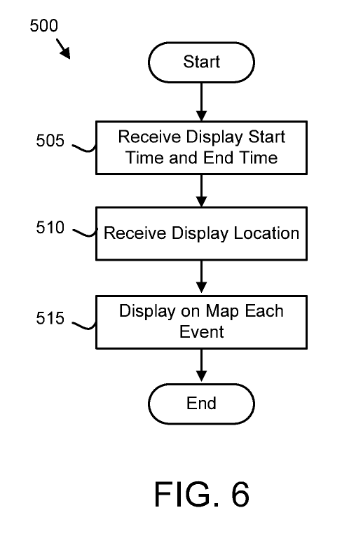

FIG. 6 is a schematic flow chart diagram illustrating one embodiment of a method 500 for displaying temporal information. The method 500 may be embodied in the system 100 and/or the computer 300. The method 500 may be performed by a computer readable storage medium such as the memory 310 having computer readable program code embodied thereon. The computer readable program code when executed by the processor 305 may perform the functions of the method 500.

The method 500 starts, and in one embodiment the client 115 receives 505 a display start time and the display end time. The display start time and the display end time may be received from markers on a temporal slider. A first temporal slider marker may be positioned to a display start date, a display start time, or combinations thereof. A second temporal slider marker may also be positioned to a display end date, a display end time, or combinations thereof. The client 115 may communicate the display start time and the display end time through the network 110 to the server 105. The display start time and the display end time may form the display interval 410.

In an alternate embodiment, the display start time and the display end time are received as numerical inputs. A date may also be received.

The client 115 further receives 510 a display location. The display location may be global positioning system coordinates, an address, a location description, or combinations thereof. The display location may include a spatial location and a radius. Alternatively, the display location comprises a plurality of spatial locations that enclose an area.

In one embodiment, a display area is defined as a specified area around the display location. The display area may be proportioned for a display size such as a browser window, a mobile telephone display, or the like. Alternatively, the display area may be pre-specified.

In one embodiment, the display location is the location of the client 115. Alternatively, the display location is a center of a map. In a certain embodiment, the display location is a specified point on the map. In one embodiment, the client 115 communicates the display start time and the display end time to the server 105. In addition, the client 115 may communicate the display location to the server 105.

In one embodiment, the client 115 receives selection criteria. The client 115 may communicate selection criteria to the server 105.

The server 105 may search the event database 200 using the display start time, the display end time, the display location, and/or the selection criteria. The server 105 may further select one or more event entries 205 and communicate the event entries 205 to the client 115.

In an alternate embodiment, the client 115 may search the event database 200 or portion of the event database 200 stored on the client 115. The client 115 may select one or more event entries 205 using the display location, the display start time, and the display end time. In addition, the client 115 may employ the characteristics 232 select the event entries 205.

The client 115 displays 515 on a map each selected event with an event entry 205 with an event location within an area of the map and an event time interval matching the display start time and the display end time and the method 500 ends. Each event includes an event location 215 within an area of the map and an event time interval matching the display start time and the display end time. In addition, each event may have a characteristic 230 matching the selection criteria.

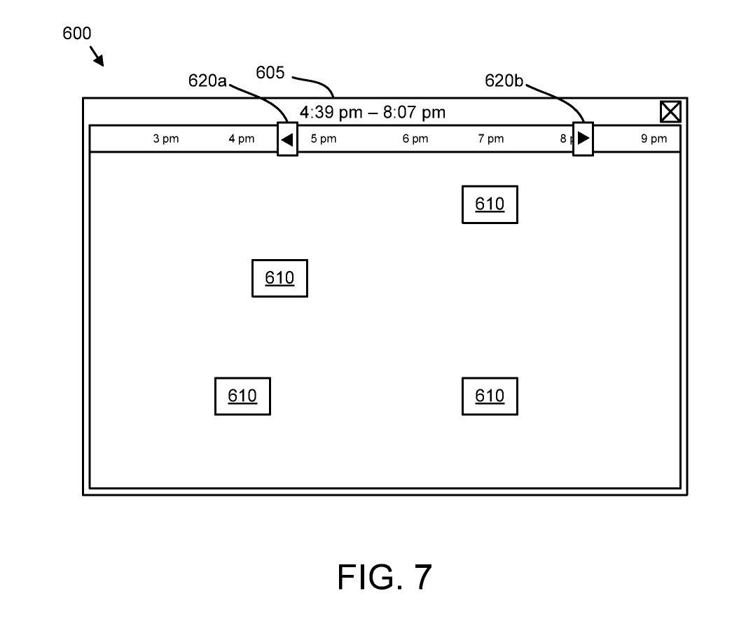

FIG. 7 is a screenshot illustrating one embodiment of a map 600. The map 600 may have an area comprising all display locations. The map 600 further comprises a temporal slider 605. The temporal slider 605 may have a first marker 620a and the 2nd marker 620b. The temporal slider markers 620 may be set to a display start time and a display end time. In one embodiment, the display start time of the temporal slider 605 is set to the current time.

In one embodiment, the display location is a center of the map 600. Alternatively, the display location may have been previously specified. The display location may also be the current location of the client 115. In addition, the display location may be selected from a description input.

The server 105 may select event entries 205 that match the display location, the display start time, and the display end time. The events 610 for these event entries 205 are displayed on the map 600. In one embodiment, an icon for each event 600 is selected based on the event name 210, the characteristics 230, or combinations thereof.

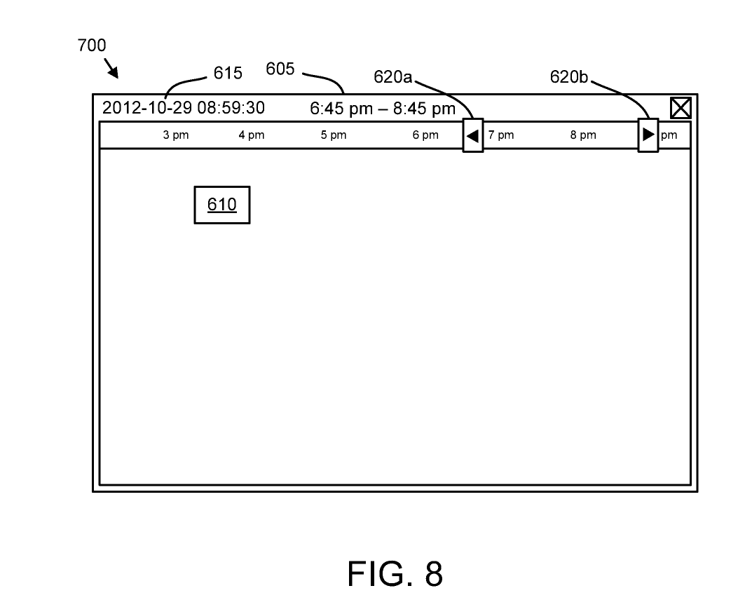

FIG. 8 is a screenshot illustrating one alternate embodiment of the map 600. The map 600 includes a temporal slider 605. In addition, a date 615 may be entered. The event 610 matching the display start time, the display end time, and the display location is displayed on the map 600

By displaying events 610 that match the display start time, the display end time, and the display location, the embodiments allow a user of the client 115 to more rapidly and easily identify suitable events. As a result, the user is more reliably appraised of the available events

The attached patent disclosure, entitle Patent Disclosure of Cameron Edwards, is incorporated herein.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for displaying temporal information comprising:
receiving, by use of a processor, a display start time and a display end time;
receiving a display location; and
displaying on a map each event of a plurality of events with an event location within an area of the map and an event time interval matching the display start time and the display end time.

2. The method of claim 1, further comprising receiving a selection criteria and displaying on the map each event of the plurality of events with an event location within an area of the map, an event time interval matching the display start time and the display end time, and a characteristic matching the selection criteria.

3. The method of claim 1, wherein the display start time and the display end time are received from markers on a temporal slider.

4. The method of claim 1, wherein the display start time and display end time are numerical inputs.

5. The method of claim 1, wherein the event time interval matches the display start time and the display end time if an event start time is subsequent to the display start time and prior to the display end time.

6. The method of claim 1, wherein the event time interval matches the display start time and the display end time if the event time interval overlaps a display interval between the display start time and the display end time.

7. The method of claim 1, wherein the event time interval matches the display start time and the display end time if the event time interval is within a display interval between the display start time and the display end time.

8. The method of claim 1, wherein each event is of an event type selected from the group consisting of a performance, an exhibition, and a sporting event.

9. A computer program product for displaying temporal information, the computer program product comprising:
a non-transitory computer readable storage medium having computer readable program code embodied therein, the computer readable program code configured to:
receive a display start time and a display end time;
receive a display location; and
display on a map each event of a plurality of events with an event location within an area of the map and an event time interval matching the display start time and the display end time.
